(19) United States
(12) Patent Application Publication
(10) Pub. No.: US 2010/0004000 A1
(43) Pub. Date: Jan. 7, 2010

(54) Method for Automatically Changing Incoming Call Alert Profile Upon the Current Location

(75) Inventor: Wen-Chi Chen, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ARIMA COMMUNICATIONS CORP., Taipei (TW)

(21) Appl. No.: 12/167,634

(22) Filed: Jul. 3, 2008

(51) Int. Cl. H04Q 7/32

(52) U.S. Cl. 455/456.1

(57) ABSTRACT

A method for automatically changing incoming call alert profile upon the current location, implements on a GPS-functioned portable communication device. The method continually obtains a location coordinate, compares the location coordinate with a comparison list to match an incoming call alert profile for the portable communication device's current incoming call alert profile. Thus, wherever the portable communication device moves to, a reaction will be presented automatically according to the current incoming call alert profile when an incoming call comes.

### BACKGROUND

1. Field of Invention

This invention is related to a method for providing incoming call alert profiles, and more particularly to a method for a portable communication device to automatically provide an incoming call alert profile according to where the portable communication device is currently located.

2. Description of Related Art

Normally, an ordinary mobile phone has a variety of incoming call alert profiles (e.g. general, silent, meeting, or outdoor mode etc.). These incoming call alert profiles are selected manually according to the environment the user is currently in. Thus, choosing a proper incoming call alert profile to present a proper incoming call alert in a specific environment will save user from inconveniences and embarrassment.

For example in an office with a policy that forbids audible ringing, when the user is in the office, the user must switch the mobile phone off or set the current incoming call alert profile to the “silent” or “vibrate” mode thereof. However, the user might possibly forget to change the current incoming call alert profile into the “general” or “outdoor” mode thereof, when the user leaves the office, since the incoming call alert profile on the mobile phone must be changed manually again. Thus, the important calls for the user might be missed due to the unnoticeable incoming call alert.

In contrast with that, whenever the user enters the office, the user also might forget to change the current incoming call alert profile into the “silent” or “vibrate” mode thereof. Thus, the user always bothers or annoys others and violates the policy of forbidding vocal ringing.

Also, although the mobile phone provides the user a function to automatically switch the power on/off in a predetermined time, the user cannot technically predict the time which the user enters or leaves the office, not to mention other places (e.g. gasoline station, hospital or museum) that the user will not go to routinely. Therefore, if the user forgets to change the current incoming call alert profile, the user may be inconvenienced and embarrassed when the phone rings with an inappropriate incoming call alert profile.

### SUMMARY

In view of the foregoing, a first aspect of the present invention is to provide a method for a portable communication device to provide a location-dependent incoming call alert profile. Thus, wherever the portable communication device is located, a proper incoming call alert profile will be set automatically by the portable communication device to prevent any inconveniences or embarrassments happening.

Therefore, the present invention provides a method for automatically changing incoming call alert profile upon the current location, which is implemented on a portable communication device. The method comprises steps of using a GPS module to continually obtain the location coordinate of the portable communication device, comparing the location coordinate with a comparison list of the portable communication device to match the corresponding incoming call alert profile, and setting the matched incoming call alert profile for the current incoming call alert profile of the portable communication device. Thus, wherever the portable communication device is located, a corresponding reaction will be presented automatically according to the matched incoming call alert profile when an incoming call arrives.

### BRIEF DESCRIPTION OF THE DRAWINGS

The structure and the technical means adopted by the present invention to achieve the above and other objectives can be best understood by referring to the following detailed description of the preferred embodiments and the accompanying drawings, where:

FIG. 1 is a function block of the portable communication device according to the present invention;

FIG. 2A is a schematic view of a comparison list according to the first embodiment of the present invention;

FIG. 2B is a schematic view of the other kind of comparison list according to the second embodiment of the present invention;

FIG. 2C is a schematic view of another kind of comparison list according to the third embodiment of the present invention;

FIG. 3 is a flow chart according to the present invention.

### DESCRIPTION OF THE PREFERRED EMBODIMENTS

It is to be understood that the following disclosure provides one or more preferred embodiment, or examples, for implementing different features of the disclosure. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

This invention is to disclose a method for automatically changing incoming call alert profile based on the current location of the mobile. The method can be implemented on a portable communication device equipped with a GPS function. The portable communication device first obtains location coordinates continually. Then, the portable communication device obtains a proper incoming call alert profile accommodating the location coordinate of the current location. Finally, the portable communication device sets the matched incoming call alert profile for the current incoming call alert profile. Therefore, when the mobile communications device receives an incoming, the incoming call alert profile of the portable communication device is determined by the location of the device.

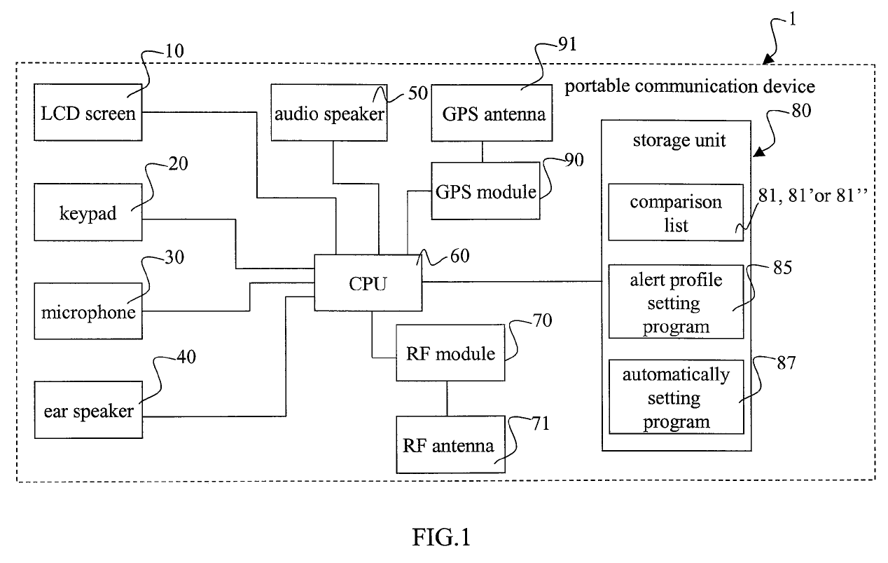

Refer to FIG. 1. FIG. 1 is a function block of the portable communication device according to the present invention. The portable communication device 1, for example can be a mobile phone, PDA, or PHS etc., comprises a LCD screen 10, a keypad 20, a microphone 30, an ear speaker 40 and an audio speaker 50 thereon. The portable communication device 1 also comprises a CPU 60, a RF module 70, a storage unit 80 and a GPS module 90 therein. The CPU 60 electrically connects to the LCD screen 10, the keypad 20, the microphone 30, the ear speaker 40, the audio speaker 50, the RF module 70, the storage unit 80 and the GPS module 90 respectively.

The RF module 70 comprises a RF antenna 71, and the GPS module 90 comprises a GPS antenna 91 receiving and updating a set of coordinate data to provide a location coordinate of where the portable communication device is currently located.

The storage unit 80 comprises a comparison list 81, 81′ or 81″, an alert profile setting program 85 and an automatically set program 87. The alert profile setting program 85 provides different kinds of incoming call alert profiles (e.g. “general”, “outdoor”, “silent”, “vibrate”, “meeting” or “shut off” mode) for users to choose for the current incoming call alert profile of the portable communication device 1. The automatically set program 87 is used for the process in associated with what the invention discloses.

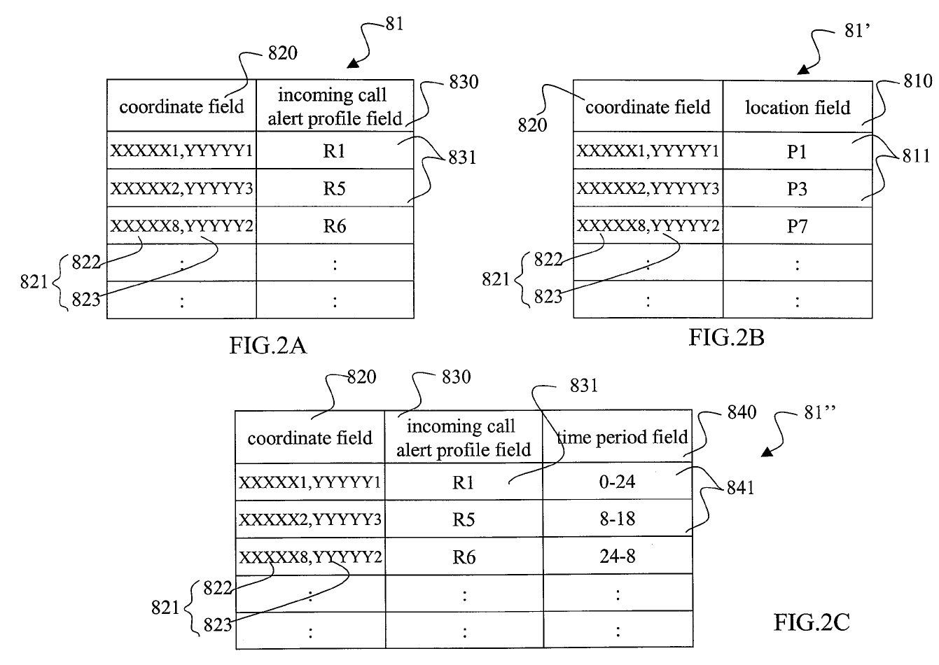

Refer to FIG. 2A, FIG. 2B and FIG. 2C. The comparison list 81, 81′ or 81″ comprises a combination of a location field 810, a coordinate field 820, an incoming call alert profile field 830 and a time period field 840. The location field 810 records a number of different public locations such as hospital, school, department store, gasoline station and library etc. In practice, these above public locations are classified into one of location groups, and each location group respectively represents one group of codes (P1˜Pn), such as P1 for hospital, P4 for transportation station and P6 for gasoline station. Thus, the location field 810 also allows recording the group codes only.

The coordinate field 820 records a number of coordinate information 821 of the locations or group codes 811 in the location field 810 and each of the coordinate information is respectively combined with the longitude range 822 and the latitude range 823.

The incoming call alert profile field 830 records a number of profile codes 831 (R1˜Rn) in which each of the profile codes 831 represents one incoming call alert profile and helps the portable communication device 1 to identify the location in order to automatically set the current incoming call alert profile. The time period field 840 records a number of time periods 841 (e.g. 00:00˜24:00, 22:00˜08:00) in which each of the time periods 841 corresponds to one of the incoming call alert profiles. Thus, the portable communication device 1 can be limited to set the corresponding incoming call alert profile for the current incoming call alert profile in a predetermined time period 841.

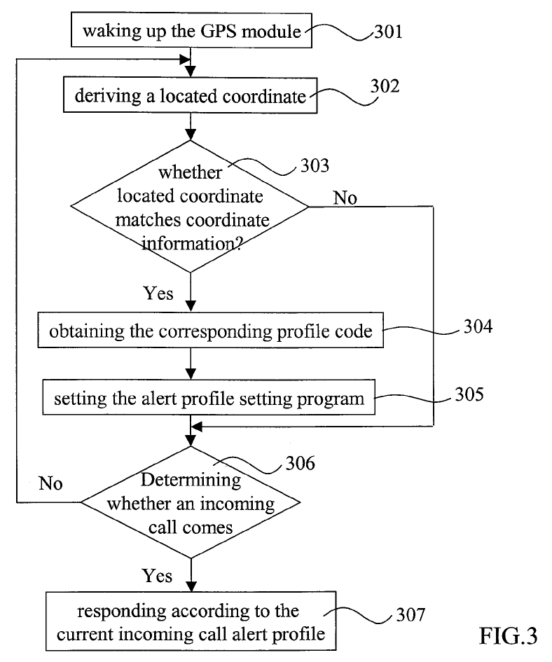

In this invention, when the automatically set program 87 is activated, the CPU 60 complies with the following steps as showing in FIG. 3, a flow chart according to the present invention:

In step (301) waking up the GPS module 90:

After the GPS module 90 is woken up, the GPS module 90 activates the GPS antenna 91 to continually obtain a set of coordinate data from outside and update the coordinates with the latest sets of coordinate data;

In step (302) deriving the location coordinate of the portable communication device 1:

After the GPS antenna 91 updates the latest set of coordinate data, the GPS module 90 calculates the set of coordinate data into the latest location coordinates of where the portable communication device is currently located;

In step(303) determining whether the location coordinate matches one of the coordinate information 821 from the comparison list 81, 81′ or 81″:

The CPU 60 compares the latest location coordinate with all of the coordinate information 821 from the comparison list 81, 81′ or 81″ to check if the location coordinate matches one of the coordinate information 821. If the location coordinate matches one of the coordinate information 821, process step (304), otherwise, if the location coordinate mismatches any of the coordinate information 821, process step (306);

In step (304) obtaining the profile code 831 in accordance with the matched coordinate information 821:

In this step, three embodiments are used to obtain the profile code 831 in different comparison lists 81, 81′ and 81″:

Embodiment I: the comparison list 81 with the built-in default profile codes 831 (see FIG. 2A).

Since the comparison list 81 has been built with the default profile code 831, when the portable communication device 1 is at a location whose coordinate is within one of the coordinate information 821 in the comparison list 81, the CPU 60 can just directly obtain the corresponding profile code 831 and set an incoming call alert profile that corresponds to the profile code 831 for the current incoming call alert profile of the portable communication device 1. For instance, the coordinate information 821 and the corresponding profile code 831 (e.g. silent mode R1) for a hospital have been built in the comparison list 81. Once a user with the portable communication device 1 enters into the hospital, the portable communication device 1 immediately changes the current incoming call alert profile into the corresponding incoming call alert profile (i.e. silent mode R1) according to the comparison list 81.

Embodiment ii: the comparison list 81′ without the profile codes 831 (see FIG. 2B) but the group codes 811, and the portable communication device 1 has an embedded predetermined rule in the CPU 60.

When the portable communication device 1 is at a location whose coordinate is within one of the coordinate information 821 in the comparison list 81′, the CPU 60 compares the obtained group code 811 with the embedded predetermined rule to derive a profile code 831 that represents one of the incoming call alert profiles for the current incoming call alert profile of the portable communication device 1.

For instance, once a user with the portable communication device 1 is at a location whose coordinate is within one of the coordinate information 821 and the coordinate corresponds to a group code 811 (e.g. P4), then the CPU 60 based on the group code 811 derives a profile code 831 (e.g. R2) for outdoor mode of incoming call alert profile.

In view of the reality in practicing the step (304), it is convenient for user to collect the group code 811 of the location than to collect the default profile code 831.

Embodiment iii: the comparison list 81″ with time periods 841 and the corresponding profile code 831 (see FIG. 2C).

When the portable communication device 1 is at a location whose coordinate is within one of the coordinate information 821 in the comparison list 81″, the CPU 60 reads a system time of the portable communication device 1 and compares the system time with the time period 841 of the time period field 840 corresponding to the coordinate information 821. The CPU 60 determines that the system time is within one of the time periods 841, the CPU 60 derives a profile code 831 that represents one of the incoming call alert profiles for the current incoming call alert profile of the portable communication device 1.

In step (305) setting the alert profile setting program 85 according to the derived profile code 831:

The CPU 60 initiates the alert profile setting program 85 and compulsorily sets the corresponding incoming call alert profile for the current incoming call alert profile according to the derived profile code 831 if the current incoming call alert profile is not the same as the derived profile code 831 represents.

In step (306) determining whether an incoming call arrives:

When the portable communication device 1 is waiting for the incoming call under an idle status, the CPU 60 monitors whether the RF antenna 71 receives an incoming call signal, if the RF antenna 71 receives an incoming call signal, the CPU 60 process step (307), otherwise, if the RF antenna 71 does not receive any incoming call signal, the CPU 60 back to process step (302) to monitor whether the current location of the portable communication device 1 changes. Since the portable communication device 1 can be moved by the user, it is very important that the portable communication device 1 can update the location coordinate simultaneously with the movement of the portable communication device 1.

Step (307) outputting a reaction according to the current incoming call alert profile:

The CPU 60 arranges the corresponding incoming call alert or other reactions according to the current incoming call alert profile. If the current incoming call alert profile is in silent mode, the CPU 60 silences the audio speaker 50, or if the current incoming call alert profile is in shut off mode, the CPU 60 disable the RF antenna 71 from receiving the incoming call signals when an incoming call comes.

The comparison list 81, 81′ or 81″ is editable by the user to input information of the location field 810, the coordinate field 820, the incoming call alert profile field 830 or the time period field 840. Thus, the user can fill up some coordinate information 821 of the user's office, school or home in the coordinate field 820, the proper profile codes 831, and the time periods 841 by his/her choice.

Also the incoming call alert profile field 830 can be edited manually and the profile codes 831 will be automatically inputted after providing the group codes 831 for the user to select, such as P1˜P3 relatives to R1, P4˜P5 relatives to R2, or P6 relatives to R3.

Nowadays information on “Internet” is easy to retrieve, it makes sense that the coordinates of most public locations in cities can be provided for free or by charge. Also, when these public locations' coordinates are provided, a default incoming call alert profile corresponding to one of these public locations may be provided with the corresponding public location. Therefore, when the content in the comparison list 81, 81′ or 81″ is plenty and correct, the present invention is achievable.

Although the present invention has been described in considerable detail with reference in the certain preferred embodiments thereof, other embodiments do not only limit the number of the wires and the conductive pins to the mentioned information above. The number of the wires and the conductive pins can be modified based on the realistic demands. Therefore, the spirit and scope of the appended claims should not be limited to the description of the preferred embodiments contained herein.

What is claimed is:

1. A method for automatically changing incoming call alert profile upon the current location, which implements on a portable communication device, the method comprises:
(a) obtaining a location coordinate with a GPS module of the portable communication device;
(b) comparing the location coordinate with a comparison list of the portable communication device to match a corresponding incoming call alert profile from the comparison list; and
(c) setting the matched incoming call alert profile for the current incoming call alert profile of the portable communication device, wherein when an incoming call of the portable communication device arrives, the portable communication device presents a reaction according to the matched incoming call alert profile.

2. The method for automatically changing incoming call alert profile upon the current location as claimed in claim 1, wherein the step (a) comprises:
activating a GPS antenna of the GPS module to continually obtain and update a set of coordinate data; and
deriving the location coordinate of the portable communication device by calculating the set of coordinate data by the GPS module.

3. The method for automatically changing incoming call alert profile upon the current location as claimed in claim 2, wherein the comparison list comprises a plurality of coordinate information, and each of the coordinate information consists of a longitude range and a latitude range.

4. The method for automatically changing incoming call alert profile upon the current location as claimed in claim 3, wherein each of the coordinate information respectively corresponds to a profile code that represents one of incoming call alert profiles.

5. The method for automatically changing incoming call alert profile upon the current location as claimed in claim 4, wherein the step (b) further comprises:
comparing the location coordinate with the coordinate information from the comparison list to determine whether the location coordinate matches one of the coordinate information thereof; and
When the location coordinate matches one of the coordinate information thereof, obtaining the profile code according to the matched coordinate information.

6. The method for automatically changing incoming call alert profile upon the current location as claimed in claim 5, wherein after reading the profile code thereof, the method further comprises:
compulsorily setting the corresponding incoming call alert profile for the current incoming call alert profile of the portable communication device according to the obtained profile code.

7. The method for automatically changing incoming call alert profile upon the current location as claimed in claim 3, wherein each of the coordinate information respectively corresponds to at least one time period and a profile code that represents one of incoming call alert profiles.

8. The method for automatically changing incoming call alert profile upon the current location as claimed in claim 3, wherein the step (b) further comprises:
comparing the location coordinate with the coordinate information from the comparison list to determine whether the location coordinate matches one of the coordinate information thereof;
When the location coordinate matches one of the coordinate information thereof, comparing a system time of the portable communication device with the at least one time period corresponding to the matched coordinate information to determine whether the system time is within the at least one time period; and
When the system time is within the at least one time period, obtaining the profile code according to the matched coordinate information.

9. The method for automatically changing incoming call alert profile upon the current location as claimed in claim 8, wherein after obtaining the parameter of the incoming call alert profile according to the matched coordinate information, the method further comprises:
compulsorily setting the corresponding incoming call alert profile for the current incoming call alert profile of the portable communication device according to the obtained profile code.

10. The method for automatically changing incoming call alert profile upon the current location as claimed in claim 3, wherein each of the coordinate information respectively corresponds to a group code that represents one of location groups.

11. The method for automatically changing incoming call alert profile upon the current location as claimed in claim 10, wherein the step (b) further comprises:
comparing the location coordinate with the coordinate information from the comparison list to determine whether the location coordinate matches one of the coordinate information thereof;
When the location coordinate matches one of the coordinate information thereof, obtaining the group code according to the matched coordinate information;
comparing the obtained group code with an embedded predetermined rule of the portable communication device to derive a profile code that represents one of incoming call alert profiles.

12. The method for automatically changing incoming call alert profile upon the current location as claimed in claim 11, wherein after obtaining the parameter of the incoming call alert profile according to the matched coordinate information, the method further comprises:
compulsorily setting the corresponding incoming call alert profile for the current incoming call alert profile of the portable communication device according to the derived profile code.

13. The method for automatically changing incoming call alert profile upon the current location as claimed in claim 1, wherein when none of the incoming call comes in the step (c), processing the step (a).
